(19) United States
(12) Patent Application Publication
(10) Pub. No.: US 2010/0259683 A1
(43) Pub. Date: Oct. 14, 2010

(54) Method, Apparatus, and Computer Program Product for Vector Video Retargeting

(75) Inventor: Vidya Setlur, Cupertino, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/420,555

(22) Filed: Apr. 8, 2009

(51) Int. Cl. H04N 9/74; H04N 9/64

(52) U.S. Cl. 348/581; 348/715; 348/E09.037; 348/E09.055

(57) ABSTRACT

In accordance with an example embodiment of the present invention, a method for vector video frame retargeting comprises identifying one or more objects within a vector video frame, determining one or more importance values for the one or more identified objects and retargeting the video frame based at least in part on at least one of the one or more importance values corresponding to at least one identified object.

### TECHNICAL FIELD

Embodiments of the present invention relate generally to image transformation, and, more particularly, relate to a method, apparatus, and a computer program product for vector video retargeting.

### BACKGROUND

Recent advances in mobile devices and wireless communications have provided users with ubiquitous access to online information and services. The rapid evolution and construction of wireless communications systems and networks has made wireless communications capabilities accessible to almost any type of mobile and stationary device. Technology advances in storage memory, computing power, and battery power have also contributed to the evolution of mobile devices as important tools for both business and social activities. As mobile devices become powerful from both a processing and communications standpoint, additional functionality becomes available to users. For example, with sufficient processing power, display capability and communications bandwidth, a mobile device may support video applications, such as live video.

### BRIEF SUMMARY

Methods, apparatuses, and computer program products for retargeting vector video frames, are described. In this regard, retargeting refers to modification of an input video frame for display on a particular display screen, possibly smaller in size than the resolution of the input video frame. According to an aspect of the present invention, the content of a video frame undergoes a non-uniform modification. One or more objects within the video frame are identified and importance values for the objects are determined. In the process of identifying an object, background region of the video frame may also be identified.

According to an example embodiment of the present invention, the details of at least one object are enhanced or generalized based at least in part on the importance value of the object. For example, an object with a high importance value has higher detail level than another object with a low importance value after video frame retargeting. The ratio between the size of an object with a high importance value and the size of an object with a low importance value may change due to retargeting resulting in the object with a high importance value appearing relatively larger. On the other hand, an object or background region with a relatively low importance value may appear, in the retargeted video frame, relatively smaller and/or with less detail than it appears in the original video frame.

Various example embodiments of the present invention are described herein. According to an example embodiment, a method for vector video frame retargeting comprises identifying one or more objects within a vector video frame, determining one or more importance values for the one or more identified objects, and retargeting the video frame based at least in part on at least one of the one or more importance values for the one or more identified objects.

According to another example embodiment, an apparatus for vector video frame retargeting comprises a memory unit for storing the vector video frame and a processor. The processor is configured to identify one or more objects within the vector video frame, determine one or more importance values for the one or more identified objects and retarget the video frame based at least in part on at least one of the one or more determined importance values for the one or more identified objects.

According to another example embodiment a computer program product comprises at least one computer-readable storage medium having executable computer-readable program code instructions stored therein. The computer-readable program code instructions of the computer program product are configured to identify one or more objects within a vector video frame, determine one or more importance values for the one or more identified objects and retarget the video frame based at least in part on at least one of the one or more determined importance values for the one or more identified objects.

According to yet another example embodiment, an apparatus comprises means for identifying one or more objects within a vector video frame, means for determining one or more importance values for the one or more identified objects and means for retargeting the video frame based at least in part on at least one of the one or more determined importance values for the one or more identified objects.

### BRIEF DESCRIPTION OF THE DRAWING(S)

Having thus described the invention in general terms, reference will now be made to the accompanying drawings, which are not necessarily drawn to scale, and wherein:

FIG. 1 is a flowchart of a method for vector video retargeting according to various example embodiments of the present invention;

FIG. 2a is an illustration of predefined collections of pixels and approximated lines according to various example embodiments of the present invention;

FIG. 2b is an illustration of line approximations using Bezier Curves according to various example embodiments of the present invention;

FIG. 3 is an illustration of facial recognition using Haar-like facial histograms according to various example embodiments of the present invention;

FIG. 4 is an illustration of the results of various retargeting operations on a video frame according to various example embodiments of the present invention;

FIG. 5 is a block diagram of an apparatus for vector video retargeting according to various example embodiments of the present invention;

FIG. 6 is a flowchart of another method for vector video retargeting according to various example embodiments of the present invention;

FIG. 7a shows an example vector video frame comprising two objects and a background region according to various example embodiments of the present invention;

FIG. 7b shows an example of a uniformly scaled version of the vector video frame in FIG. 7a according to various example embodiments of the present invention; and

FIG. 7c shows an example of a non-uniformly retargeted version of the vector video frame in FIG. 7a according to various example embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, operated on, and/or stored in accordance with embodiments of the present invention. The terms “spatial detail” and “spatial detail level” and similar terms may be used interchangeably to refer to current spatial detail level information of a video frame and/or current spatial detail information of an object in the video frame. Moreover, the term “exemplary,” as used herein, is not provided to convey any qualitative assessment, but instead to merely convey an illustration of an example. The term “video frame” as used herein is described with respect to a frame that is included within a series of frames to generate motion video. However, it is contemplated that aspects of the present invention are generally applicable to images and therefore example embodiments of the present invention may also be applied to images that are not part of a video frame sequence, e.g., a photograph.

Uniformly scaling video and images, designed for a large display screen size, to a smaller resolution, e.g. corresponding to the display size of a mobile device, may result in video frames being displayed with significant loss of detail. In uniform scaling, an important object may be rendered at a small resolution where details of the object are not recognizable. The degradation in vector image or video frame quality impacts the user's experience negatively.

According to an example embodiment of the present invention, video frames are retargeted in a non-uniform manner to preserve or improve the recognizability and/or saliency of key objects in the video frames. In this regard, a video frame is received, or converted, into a vector format. Objects within a vector video frame are identified and the importance of the identified objects is evaluated. For example, importance values for the objects are determined. Based on the relative importance of the objects, the different objects and the background are, for example, scaled and/or simplified differently. As a result, the vector video frame is retargeted for any display size using perceptually motivated resizing and grouping algorithms that budget size and spatial detail for each object based on the relative importance of the objects and background. According to an example embodiment of the present invention, video frames are retargeted on a frame-by-frame basis. Object based information, such as spatial detail information, may also be reused for a series of video frames with respect to common objects within the series of frames.

An object with relatively high importance is associated with a relatively high level of spatial detail, or granularity of detail, in the retargeting process. Spatial detail is, for example, a measure of the feature density of an object. In this regard, a presentation of a soccer ball having black and white polygon features may have a relatively higher level of spatial detail than a white sphere. An object with relatively high importance may also be associated with a relatively higher size ratio compared to objects with relatively low importance. The relative higher size ratio of the object may lead to higher feature density of the object.

On the other hand, generalizing or simplifying an object leads to a decrease in the feature density of the same object resulting in less spatial detail. By generalizing an object, the object becomes less specific since characteristic may be suppressed. Various types of generalization may be implemented including elimination, typification, and/or outline simplification as further described below.

In a conceptual sense, a goal of a video frame, or a series of video frames, is to communicate a story. Often the story is communicated to the viewer via a few key objects present in the video frame and the interaction of the key objects with other objects. The non-key objects within the frame provide context for the key objects, and are therefore are referred to as contextual objects. To achieve the goal of communicating the story on a device with a smaller display, example embodiments of the present invention display key object at a sufficient size and/or at a spatial detail for recognition and saliency. The contextual objects in the video frame may be of lesser importance, and therefore generalized or subdued. According to an example embodiment of the present invention, the recognizability of the interactions between key objects after the video frame is re-sized is preserved by maintaining the saliency of key objects.

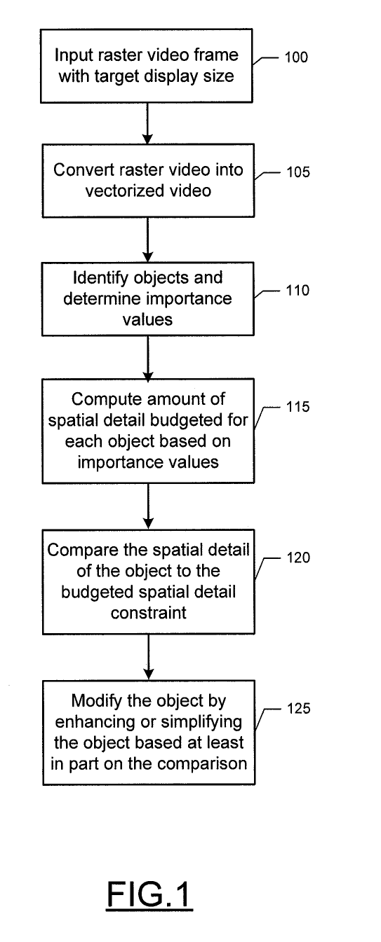

FIG. 1 depicts an example method of the present invention for vector video retargeting. According to an example embodiment, a raster video frame is received and a target display size is determined at block 100. The target display size is determined, for example, by retrieving information about the target display.

At 105, the raster video frame is converted into a vector video frame. For example, quantizing the content of the raster video frame may facilitate the identification of different regions in the video frame. According to an example embodiment, quantization is applied in the hue, saturation, value (HSV) color space. The colors within the video frame are clamped in HSV color space. More specifically, the hue of each pixel of the video frame is constrained to the nearest of twelve primary and secondary colors. The saturation and value are clamped, for example to 15% and 25%, respectively. By clamping the colors, the video frame undergoes a tooning effect. The video frame appears segmented into different homogeneous color regions after quantization.

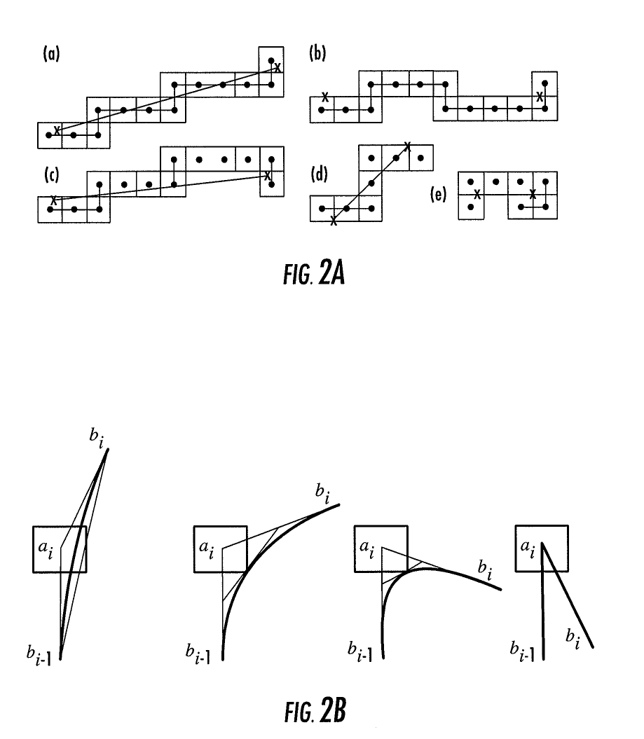

In order to perform vectorization of the raster video frame, according to an example embodiment, a common group of pixels may be identified. By identifying the pixels associated with a group, lines may be drawn when predefined pixel formations are identified as depicted in FIG. 2a. Example embodiments of the present invention may then approximate the lines as a series of Bezier curves as depicted in FIG. 2b. Each curve may be controlled by a vertex pixel and two directions to make a smooth interpolation, resulting in a vector image.

The conversion from a raster video frame to a vector video frame may be implemented by leveraging an implicit relationship between extensible mark-up language (XML) and scalable vector graphics (SVG). In this regard, SVG structural tags may be used to define the building blocks of a specialized vector graphics data format. The tags may include the <svg> element, which is the top-level description of the SVG document, a group element <g>, which is a container element to group semantically related Bezier strokes into an object, the <path> element for rendering strokes as Bezier curves, and several kinds of <animate> elements to specify motion of objects.

The SVG format conceptually consists of visual components that may be modeled as nodes and links. Elements may be rendered in the order in which they appear in an SVG document or file. Each element in the data format may be thought of as a canvas on which paint is applied. If objects are grouped together with a <g> tag, the objects may be first rendered as a separate group canvas, then composited on the main canvas using the filters or alpha masks associated with the group. In other words, the SVG document may be viewed as a directed acyclic tree structure proceeding from the most abstract, coarsest shapes of the objects to the most refined details rendered on top of these abstract shapes. This property of SVG allows example embodiments of the present inventions to perform a depth-first traversal of the nodes of the tree and manipulate the detail of any element by altering the structural definitions of that element. SVG also tags elements throughout an animation sequence alleviating the issue of video segmentation. The motion of elements may be tracked through all frames of an animation by using, for example, <animate> tags.

At 110, objects are identified in the vector video frame and importance values are determined for the objects. According to an example embodiment, techniques for determining saliency, e.g., motion detection, meta-tag information, and user input, are leveraged. According to an example embodiment, the XML format of the vector graphics structure, corresponding to a vector video frame, is parsed to identify objects and associated assigned importance values. An importance parameter is, for example, an SVG tag set by video saliency techniques. Importance parameters are constrained, for example, to be in the interval [0,1] and are indicative of an importance value associated with an object.

According to an example embodiment, object identification further comprises background subtraction. Background subtraction, is applied, for example, on the segmented video frame to isolate the important objects of the image from the unimportant background objects. According to another example embodiment, motion is leveraged to perform background subtraction. For example, regions that move tend to be more salient, and are considered part of the foreground not part of the background. As such, pixel changes may be compared between sequential video frames to find regions that change.

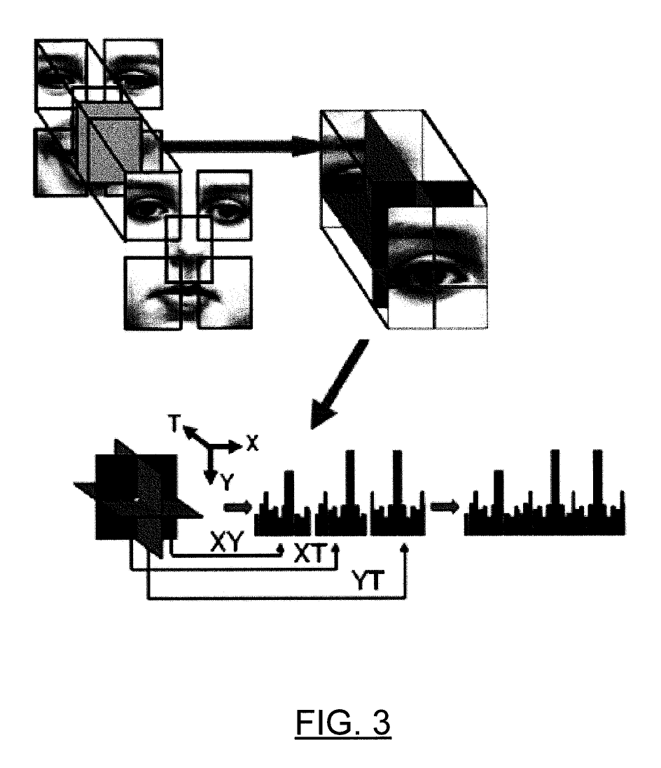

According to an example embodiment, additional measures are taken when performing object identification if the video frame comprises a face of an individual. In this regard, mere vectorization and uniform scaling may result in the loss of information associated with a key object such as the individual's face. For example, in some instances vectorization and uniform scaling of a face may cause information associated with an eye to meld into other aspects of the face, and the eye may be lost due to an over-generalization of the face. To address this issue, various example embodiments detect faces using, for example, Haar-like features. Important facial features, such as the eyes, the mouth, the nose, and the like may be detected using specialized histograms for the respective facial features as shown in FIG. 3. The histograms are, for example, combined or summed. The summed, and/or combined, histograms illustrate some similarity between different faces, but are different with respect to histograms corresponding to other objects, e.g., an image of an office building.

According to at least one example embodiment of the present invention, a combination of motion estimation and face detection is applied to determine saliency. In another example embodiment, other saliency models and/or user input are incorporated. In this regard, a video saliency metric may be generalized as a linear combination of the products of the individual weightings of each saliency model, and the corresponding normalized saliency values. The combination may take the form of

I=wᵢMᵢ+wⱼMⱼ+wₖMₖ+ . . .

where wᵢ, wⱼ, wₖ are the weights for the linear combination and Mᵢ, Mⱼ, Mₖ are the normalized values from each corresponding saliency model.

The method of FIG. 1 further comprises modifying the original resolution of the original video frame to the target resolution of the display. For example, if the original video frame has a resolution, e.g., 1280×1024, and the target resolution is, e.g., 320×256, then method in FIG. 1 comprises reducing the resolution of the vector video frame by a factor 4 in each direction, e.g. height and width. According to an example embodiment of the present invention, the vector video frame is uniformly downscaled and then objects in the resized video frame are either enhanced, e.g., by increasing object size and/or corresponding spatial detail, or simplified, e.g., by decreasing object size and/or corresponding spatial detail. The uniform downscaling of the vector video frame may be applied, for example, before or after the identification of the objects and/or the determining of the importance values at 110 of FIG. 1. The uniform downscaling of the vector video frame may also be applied after block 115 of FIG. 1.

Referring again to FIG. 1, an amount of spatial detail budgeted for each object, in the resized vector video frame, is computed at 115. The computation of the spatial detail budgeted for each object is based at least in part on the respective importance values of the objects. According to an example embodiment of the present invention an overall budget for spatial detail for the video frame is generated. The overall budget for spatial detail is then distributed between the identified objects, in a weighted manner based on the importance values of the objects, in order to compute a spatial detail budget for each object. The spatial detail budget for an object is a constraint on the spatial detail to be associated with the same object in the resized vector video frame, e.g., at the target display resolution. The generation of the budget comprises calculating a spatial detail for a given display size and/or calculating the spatial detail for the various identified objects.

For example, the total spatial detail of the non-resized vector video frame is denoted as T₁. After resizing the vector frame to the desired target size, the total spatial detail for that resized vector frame is denoted as T₂. The non-resized and resized vector frames have the same information but at different resolutions. In the case where the resized vector frame has a smaller resolution than the non-resized vector frame, T₂ is greater than T₁. According to an example embodiment of the present invention, the overall budget for spatial detail, for example denoted as B, is chosen to be equal to the total spatial detail of the non-resized vector video frame, e.g., B=T₁. In an alternative embodiment, the target total budget for the resized vector frame is defined differently. For example, the overall budget B is defined in terms of T₁ but smaller than T₁, e.g., B=B(T₁)<T₁. The spatial detail budget for an object is computed, for example, as the multiplication of the importance value, of the same object, and the overall budget for spatial detail.

In the retargeting process, the spatial detail in the resized vector video frame is updated and T2 is decreased until T2 becomes less than, and/or approximately equal to, B. The updating of the spatial detail comprises simplifying objects, with relatively low importance, to reduce their spatial detail. Objects, with relatively high importance, usually maintain a relatively high spatial detail compared to objects with low importance. In an example embodiment, the spatial detail values of relatively important objects, after the retargeting process, do not exceed the corresponding spatial detail values of the same objects in the non-resized vector video frame.

The spatial detail of a video frame at a given resolution is the sum of the spatial details of the objects within the same video frame at the same resolution. In an example embodiment, spatial detail of a video object is computed by evaluating changes in luminance in the neighborhood of at least one pixel in the same video object. The evaluation of changes in luminance, at the pixel level, is usually performed in the raster space. The neighborhood gray-tone difference matrix (NGTDM) is an example technique for evaluating spatial detail of video objects. The NGTDM provides a perceptual description of spatial detail for an image in terms of changes in intensity and dynamic range per unit area. The NGTDM is a matrix, in which the k-th entry is the summation of the differences between the luminance value of all pixels in the raster image with the average luminance value of the pixels in a neighborhood of pixel with luminance value equal to k.

In an example embodiment of the present invention, luminance values of the pixels are computed in color spaces such as YUV, where Y stands for the brightness, and U and V are the chrominance, e.g., color, components. In this regard, Y(i,j) is the luminance of the pixel at (i,j). Accordingly, the average luminance over a neighborhood centered at, but excluding (i,j), is

$${\overline{A}}_{k} = \overline{A} ( i , j ) = \frac{1}{W - 1} [ {\sum }_{m = - d}^{d} {\sum }_{n = - d}^{d} Y ( i + m , j + n ) ]$$

where d specifies the neighborhood size, W=(2d+1)², and (m,n)≠(0,0). The k-th entry in the NGTDM may be defined as

$$s ( k ) = \{ \begin{matrix}\sum \vert u - {\overline{A}}_{k} \vert , & if {N}_{k} \neq 0 \\ 0 , & otherwise\end{matrix}$$

where k is a luminance value and Nₖ is the set of all pixels having luminance value equal to k. The number of pixels Nₖ excludes pixels in the peripheral regions of width d, of the video frame, to minimize the effects of luminance changes caused by the boundary edges of the image.

The NGTDM may then be used to obtain the following computational measure for spatial detail

$$Spatial detail = \frac{{\sum }_{k = 0}^{k = G} {p}_{k} s ( k )}{{\sum }_{k = 0}^{k = G} {\sum }_{l = 0}^{l = G} \vert {kp}_{k} - {lp}_{l} \vert}$$

$${p}_{k} \neq 0 , {p}_{l} \neq 0$$

where G being the highest luminance value present in the image. The numerator may be viewed as a measure of the spatial rate of change in intensity, while the denominator may be viewed as a summation of the magnitude of differences between luminance values. Each value may be weighted by the probability of occurrence. For an N×N image, pₖ is the probability of occurrence of luminance value k, and is given by pₖ=Nₖ/n², where n=N−2d, and Nₖ is the set of all pixels having luminance value k, excluding the peripheral regions of width d. The value pₗ is the probability of occurrence of luminance value l, and is given by pₗ=Nₗn², where Nₗ is the number of pixels with luminance value l in the video frame excluding the peripheral regions of width d. If a video object changes size or color during the course of an animation, spatial detail may be recomputed for the changed object.

According to an example embodiment, T₁ is computed at 115 of FIG. 1 by evaluating the spatial detail of the non-resized vector frame using, for example NGTDM. The overall budget is chosen to be equal to T₁, e.g., B=T1. The overall budget B is then distributed among different objects in the video frame in order to compute a spatial detail constraint for at least one object. For example, if the vector video frame comprises L identified objects, denoted as O₁, O₂, . . . , O_{L}, with respective importance values I₁, I₂, . . . , I_{L}, the spatial detail constraint for an object O_{q}, where q being in {1,2, . . . , L}, is calculated as B_{q}=I_{q}×B. The value B_{q} represents the spatial detail constraint, or spatial detail budget, associated with the object O_{q}. In an alternative example embodiment, the distribution of the overall budget B among different objects, is achieved differently, e.g., B_{q}=f(I_{q})×B, where f(I_{q}) is a function of the importance values. The distribution process further includes normalizing the spatial detail constraint of each object by the corresponding area of the object, e.g.,

$${\overline{B}}_{q} = \frac{{B}_{q}}{Area of {O}_{q}} ,$$

to determine the unit spatial detail constraint B̅_{q} for each object O_{q}.

In the scaled vector frame, the spatial detail of each object is also computed, e.g., using NGTDM. For example, for the same objects O₁, O₂, . . . , O_{L} the corresponding spatial detail values S₁, S₂, . . . , S_{L} are calculated, where S₁+S₂+ . . . +S_{L}=T₂. The spatial detail value of each object is then normalized by the corresponding area of the object, e.g.,

$${\overline{S}}_{q} = \frac{{S}_{q}}{Area of {O}_{q}} ,$$

to determine the unit spatial detail S̅_{q} for each object O_{q}.

In an example embodiment, at least one unit spatial detail value of at least one object is changed, in the retargeting process, until it is less than the corresponding at least one spatial detail constraint for the same at least one object. An object of relatively high importance may be enhanced until its current unit spatial detail, e.g., S̅_{q}, is equal to the corresponding spatial detail constraint B̅_{q} for the same object. In an alternative example embodiment, S̅_{q} is changed until it is close to, but still smaller than, B̅_{q}. However, in situations where the retarget size is small, there may be insufficient space to exaggerate the size of an object. In such cases, the size of the object may remain the same as in the uniformly scaled video frame. If the original unit spatial detail of an object is greater than the unit spatial detail constraint of the same object, the object may be generalized or simplified until its unit spatial detail becomes less than or equal to the unit spatial detail constraint of the same object.

Having determined an overall spatial detail budget for the display, and individual unit budgets, or unit spatial detail constraints, for each of the identified objects, the unit spatial detail values of the objects, e.g., S̅_{q}, are compared at 120 to the respective unit spatial detail constraints, e.g., B̅_{q}. At 125, at least one object is increased in size and/or detail or simplified by modifying a corresponding detail level at 125 based at least in part on the comparison made at 120. In this manner, the budget for spatial detail may be distributed to the various identified objects, in accordance with their respective importance values.

Additional constraints that may affect redistributing of spatial detail in the frame may be derived from display configurations, and the bounds of human visual acuity. These, and other, constraints may be dictated by the physical limitations of display devices, such as the size and resolution of display monitors, the minimum size and width of objects that can be displayed, or the minimum spacing between objects that avoids symbol collision or overlap.

To generalize or simplify an object, an elimination process may be undertaken. Elimination involves, for example, selectively removing regions inside objects that are too small to be presented in the retargeted image. For example, beginning from the leaf nodes of a SVG tree, which represents the smallest lines and regions in an object, primitives are iteratively eliminated until the spatial detail constraint for the object is satisfied at the new target size.

Alternatively or additionally, generalization may include a typification process. Typification is the reduction of feature density and level of detail while maintaining the representative distribution pattern of the original feature group. Typification is a form of elimination constrained to apply to multiple similar objects. In an example embodiment, typification is applied based on object similarity. Objects similarity is determined, for example, via pattern recognition. In this regard, a heuristic of tree isomorphism within the SVG data format is used to compute a measure of spatial similarity. Each region of an object is represented as a node in the tree. Nested regions form leaves of the node. A tree with a single node, the root, is isomorphic only to a tree with a single node that has approximately the same associated properties. Two trees with example roots A and B, neither of which is a single-node tree, are isomorphic if and only if the associated properties at the roots are identical and there is a one-to-one correspondence between the sub-trees of A and of B. Typification is utilized on objects that are semantically grouped and in the same orientation.

Alternatively or additionally, outline simplification is used to generalize an object. The control points of the Bezier curves, representing ink lines at object boundaries may become too close together resulting in a noisy outline. Outline simplification reduces the number of control points to relax the Bezier curve. In an example embodiment, a vertex reduction technique, which may be a simple and fast O(n) algorithm, is used. In vertex reduction, successive vertices that are clustered too closely, for example, are reduced to a single vertex. According to an example embodiment of the present invention, control points with minimum separation are considered to be simplified iteratively until the spatial detail constraint is reached. Anti-aliasing is, for example, applied in conjunction with outline simplification to minimize the occurrence of scaling effects in the outlines of objects.

Additionally, example embodiments of the present invention may also be implemented with temporal and/or spatial coherence for a series of video frames. In this regard, temporal coherence includes maintaining a constant spatial detail level for an object throughout a series of video frames in time. Spatial coherence includes maintaining a constant spatial detail ratio between the object and other identified objects in the given retargeted frame, based on the original ratio from the original non-retargeted frame.

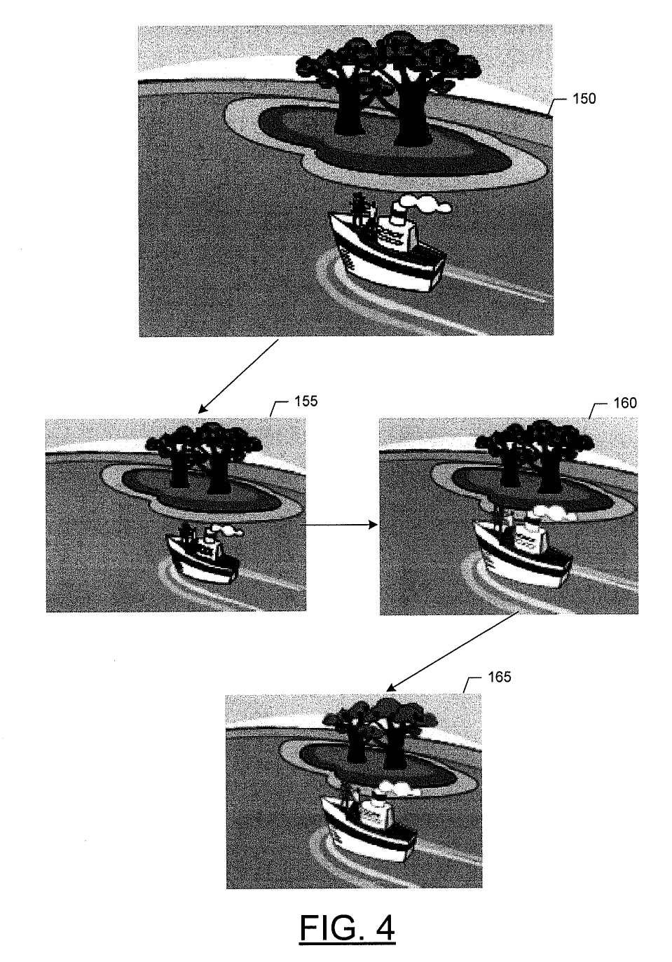

FIG. 4 provides a pictorial illustration of a retargeting process in accordance with an example embodiment of the present invention. The image 150 is the original video frame at a large scale. Image 155 is a scaled version of the original image, where a uniform scaling is performed. Image 160 depicts the condition of the image after object enhancement has been performed. Note with respect to the image 160 that the boat and the person, key or important objects, are relatively larger and more detailed than in the image 155. The enhancement is particularly apparent when noting that the boat and person in image 160 overlap the background island, whereas in the images 150 and 155 they do not. Image 165 is a depiction of the image after image generalization. Note that the tree in the background has been generalized and lesser number of fruit appear on the tree due the generalization.

In accordance with the description provided above, various example embodiments of the present invention also apply to retargeting faces in video frames. By applying non-uniform retargeting to a face object in a video frame, the face may provide basic facial gestures to be recognizable. The face may also include some degree of anonymity as detailed facial features may not be provided. This advantage may find use with online applications geared toward children that allow the children to communicate in a face-to-face manner while maintaining a level of anonymity. On the other hand, for trusted communications, example embodiments of the present invention may reduce the level of cartooning to provide recognizable details of an individual's face. Simplification on certain objects in the video, during the retargeting process, may have the effect of smoothing away details such as scars and wrinkles.

Additionally, scientific studies have shown that individuals with certain conditions, such as autism, that make it difficult to cognitively process emotion, benefit greatly from cartooned images of faces. As the example embodiments of this invention can differentially modulate the level of detail in different portions of the video, the generalized video can aid in teaching individuals with special cognitive needs concepts such as emotions.

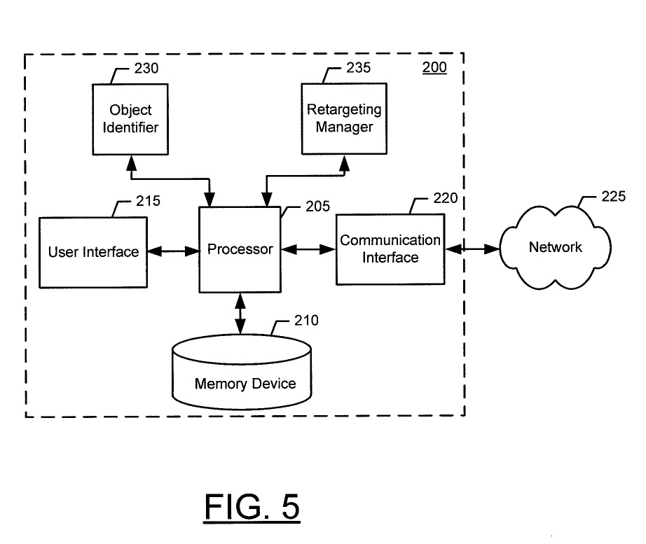

The description provided above and herein illustrates example methods, apparatuses, and computer program products for vector video retargeting. FIG. 5 illustrates another example embodiment of the present invention in the form of an example apparatus 200 that is configured to perform various aspects of the present invention as described herein. The apparatus 200 may be configured to perform example methods of the present invention, such as those described with respect to FIGS. 1 and 4.

In some example embodiments, the apparatus 200 may, but need not, be embodied as, or included as a component of, a communications device with wired or wireless communications capabilities. Some examples of the apparatus 200, or devices that may include the apparatus 200, may include a computer, a server, a network entity, a mobile terminal such as a mobile telephone, a portable digital assistant (PDA), a pager, a mobile television, a gaming device, a mobile computer, a laptop computer, a camera, a video recorder, an audio/video player, a radio, and/or a global positioning system (GPS) device, or any combination of the aforementioned, or the like. Further, the apparatus 200 may be configured to implement various aspects of the present invention as described herein including, for example, various example methods of the present invention, where the methods may be implemented by means of a hardware configured processor or a processor configured through the execution of instructions stored in a computer-readable storage medium, or the like.

The apparatus 200 may include or otherwise be in communication with a processor 205, a memory device 210, a user interface 225, an object identifier 230, and/or a retargeting manager 235. In some embodiments, the apparatus 200 may optionally include a communications interface 215. The processor 205 is embodied as various means implementing various functionality of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. In some example embodiments, the processor 205 may, but need not, include one or more accompanying digital signal processors. In some example embodiments, the processor 205 is configured to execute instructions stored in the memory device 210 or instructions otherwise accessible to the processor 205. As such, whether configured by hardware or via instructions stored on a computer-readable storage medium, or by a combination thereof, the processor 205 may represent an entity capable of performing operations according to embodiments of the present invention while configured accordingly. Thus, for example, when the processor 205 is embodied as an ASIC, FPGA or the like, the processor 205 may be specifically configured hardware for conducting the operations described herein. Alternatively, when the processor 205 is embodied as an executor of instructions stored on a computer-readable storage medium, the instructions may specifically configure the processor 205 to perform the algorithms and operations described herein. However, in some cases, the processor 205 may be a processor of a specific device (e.g., a mobile terminal) configured for employing example embodiments of the present invention by further configuration of the processor 205 via executed instructions for performing the algorithms and operations described herein.

The memory device 210 is, for example, one or more computer-readable storage media that may include volatile and/or non-volatile memory. For example, memory device 210 may include Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, or the like for enabling the processor 205 and the apparatus 200 to carry out various functions in accordance with example embodiments of the present invention. For example, the memory device 210 could be configured to buffer input data for processing by the processor 205. Additionally, or alternatively, the memory device 210 may be configured to store instructions for execution by the processor 205.

The communication interface 215 may be any device or means embodied in either hardware, a computer program product, or a combination of hardware and a computer program product that is configured to receive and/or transmit data from/to a network and/or any other device or module in communication with the apparatus 200. Processor 205 may also be configured to facilitate communications via the communications interface by, for example, controlling hardware included within the communications interface 215. In this regard, the communication interface 215 may include, for example, one or more antennas, a transmitter, a receiver, a transceiver and/or supporting hardware, including a processor for enabling communications with network 220. Via the communication interface 215 and the network 220, the apparatus 200 may communicate with various other network entities in a peer-to-peer fashion or via indirect communications via a base station, access point, server, gateway, router, or the like.

The communications interface 215 may be configured to provide for communications in accordance with any wired or wireless communication standard. The communications interface 215 may be configured to support communications in multiple antenna environments, such as multiple input multiple output (MIMO) environments. Further, the communications interface 215 may be configured to support orthogonal frequency division multiplexed (OFDM) signaling. In some example embodiments, the communications interface 215 may be configured to communicate in accordance with various techniques, such as, second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wigbee and/or the like

The user interface 225 may be in communication with the processor 205 to receive user input and/or to present output to a user as, for example, audible, visual, mechanical or other output indications. The user interface 225 may include, for example, a keyboard, a mouse, a joystick, a display (e.g., a touch screen display), a microphone, a speaker, or other input/output mechanisms.

The object identifier 230 and the retargeting manager 235 of apparatus 200 may be any means or device embodied, partially or wholly, in hardware, a computer program product, or a combination of hardware and a computer program product, such as processor 205 implementing stored instructions to configure the apparatus 200, or a hardware configured processor 205, that is configured to carry out the functions of the object identifier 230 and/or the retargeting manager 235 as described herein. In an example embodiment, the processor 205 includes, or controls, the object identifier 230 and/or the retargeting manager 235. The object identifier 230 and/or the retargeting manager 235 may be, partially or wholly, embodied as processors similar to, but separate from processor 205. In this regard, the object identifier 230 and/or the retargeting manager 235 may be in communication with the processor 205. In various example embodiments, the object identifier 230 and/or the retargeting manager 235 may, partially or wholly, reside on differing apparatuses such that some or all of the functionality of the object identifier 230 and/or the retargeting manager 235 may be performed by a first apparatus, and the remainder of the functionality of the object identifier 230 and/or the retargeting manager 235 may be performed by one or more other apparatuses.

According to various example embodiments, the processor 205 or other entity of the apparatus 200 may provide a vector video frame to the object identifier 230. In an example embodiment, the apparatus 200 and/or the processor 205 is configured to receive, or retrieve from a memory location, a raster video frame. The apparatus 200 and/or the processor further determines a desired display size. The display size may be the display size of a display included in the user interface 215. The apparatus 200 and/or the processor 205 is, for example, further configured to convert the raster video frame to a vector video frame. The apparatus 200 and/or the processor 205 is further configured to scale the vector video frame to a resolution corresponding to the desired display size.

The object identifier 230 may be configured to identify at least one object within the vector video frame. According to various example embodiments, to identify an object, the object identifier 230 is configured to segment the video frame based at least in part on identified color edges. Based on the identified color edges, an object may be identified and, in some example embodiments, a background portion of the video frame may be identified. The object identifier 230 may also be configured to subtract the background portion from the video frame. Further, in some example embodiments, the object identifier 230 may be configured to identify facial features and translate the facial features using a histogram for inclusion in the object.

According to various example embodiments, the object identifier 230 may also be configured to determine importance values. In this regard, the object identifier 230 may be configured to determine importance values using, for example, an SVG tag set by various video saliency techniques. The object identifier 230 may therefore be configured to determine and assign importance values to each of the identified objects within the video frame.

The retargeting manager 235 may be configured to retarget the video frame based at least in part on the importance value(s) for the object(s). According to various example embodiments, the retargeting manager 235 may be configured to retarget the video frame by determining a spatial detail constraint value for an object, and modifying a detail level of the object in response to a result of a comparison between the spatial detail constraint and a current spatial detail for the object. In this regard, modifying the detail level of the object may include enhancing or generalizing the object. According to various example embodiments, the retargeting manager 235 may also be configured to retarget the video frame with spatial coherence or temporal coherence. In this regard, temporal coherence may include maintaining a detail level of the object throughout a series of video frames. Spatial coherence may include maintaining a constant detail level ratio between the object and other identified objects throughout a series of video frames.

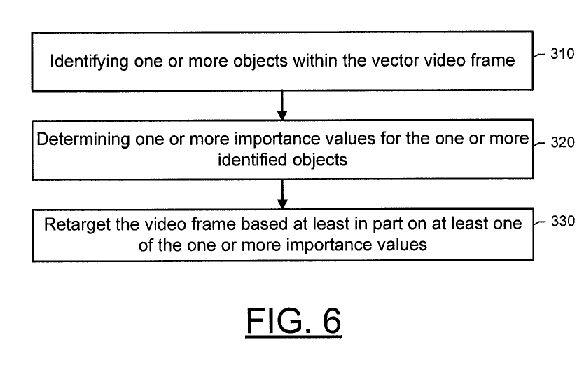

FIGS. 1 and 6 illustrate flowcharts of a system, method, and computer program product according to example embodiments of the invention. It will be understood that each block, or operation of the flowcharts, and/or combinations of blocks, or operations in the flowcharts, can be implemented by various means. Means for implementing the blocks or operations of the flowcharts, combinations of the blocks or operations in the flowcharts or other functionality of example embodiments of the invention described herein may include hardware, and/or a computer program products including a computer-readable storage medium having one or more computer program code instructions, program instructions, or executable computer-readable program code instructions store therein. In this regard, program code instructions may be stored on a memory device of an apparatus, such as the apparatus 200, and executed by a processor, such as the request processor 205. As will be appreciated, any such program code instructions may be loaded onto a computer or other programmable apparatus from a computer-readable storage medium to produce a particular machine, such that the particular machine becomes a means for implementing the functions specified in the flowcharts block(s), or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operational steps to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s), or operation(s).

Accordingly, execution of instructions associated with the blocks, or operations of the flowcharts by a processor, or storage of instructions associated with the blocks, or operations of the flowcharts in a computer-readable storage medium, support combinations of means for performing the specified functions and combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions or operations, or combinations of special purpose hardware and program code instructions.

FIG. 6 depicts an example method for vector video retargeting according to an example embodiment of the present invention. In an example embodiment, the video frame is received in raster form and converted into vector form. A desired display size, e.g., a resolution, is determined an the vector video frame is scaled to the desired display size. At 310, one or more objects are identified within the vector video frame. According to an example embodiment, identifying one or more objects includes segmenting the video frame based at least in part on color edges. Based on the color edges, one or more objects are identified and a background region of the vector video frame is also identified. According an example embodiment, the background region is subtracted from the video frame in order to identify the one or more objects. Further, in some example embodiments, identifying an object includes identifying facial features and translating the facial features using, for example, at least one histogram.

At 320, at least one importance value of at least one object of the one or more objects is determined. The video frame is retargeted at 330 based at least in part on the at least one importance value of the at least one object. According to an example embodiment, retargeting the vector video frame comprises determining at least one spatial detail constraint value for the at least one object. Retargeting the vector video frame further comprises computing at least one detail level for the at least one object and modifying the at least one detail level of the at least one object in response to a result of a comparison between the at least one spatial detail constraint and at least one current spatial detail for the at least one object. Modifying the detail level of an object includes, for example, enhancing or generalizing the object. According to an example embodiment, retargeting the video frame additionally or alternatively includes retargeting the video frame with spatial coherence or temporal coherence. Temporal coherence comprises maintaining a detail level of the object throughout a series of video frames. Spatial coherence comprises maintaining a constant detail level ratio between the object and at least one other identified object in a video frame.

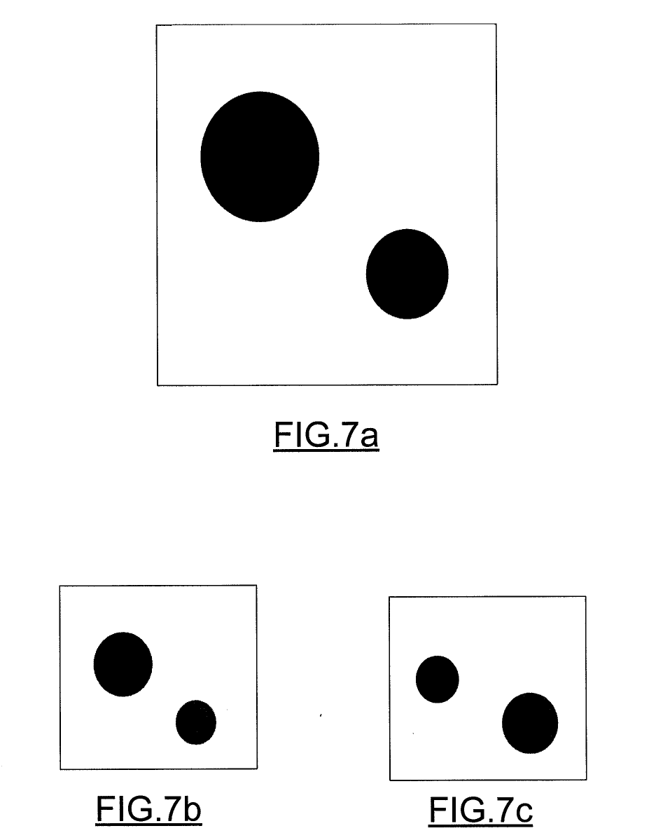

FIG. 7a shows an example vector video frame comprising two objects and a background region. The objects comprise ball1 with importance value 0.3 and ball2 with importance value 0.7. In this case, the background region has importance value 0. The width of vector video frame is 744.09448 and the height of the vector video frame is 1052.3622. Ball1 has a width value equal to 341.537 and a height value equal to 477.312. Ball2 has a width value equal to 213.779 and a height value equal to 206.862. An example SVG description of the vector frame in FIG. 7a is as follows;

```
<?xml version=″1.0″ encoding=″UTF-8″ standalone=″no″?>
<svg
    xmlns:svg=″http://www.w3.org/2000/svg″
    xmlns=″http://www.w3.org/2000/svg″
    version=″1.0″
    width=″744.09448″
    height=″1052.3622″
    id=″svg2″>
  <defs
        id=″defs4″ />
  <g
        id=″layer1″>
      <path id=”ball1” importance=”0.3” width=”341.537”
          height=”477.312” d=″M 340,303.79074 A 135.71428,
148.57143 0 1 1 68.571442,303.79074 A 135.71428,148.57143 0 1 1
          340,303.79074 z″ style=″fill:#0000ff″ />
      <path id=”ball2” importance=”0.7” width=”213.779”
          height=”206.862” d=″M 634.28571,572.36218 A
94.285713,102.85714 0 1 1 445.71429,572.36218 A
94.285713,102.85714 0 1 1 634.28571,572.36218 z″
          style=″fill:#008000″ />
  </g>
</svg>
```

FIG. 7b shows an example of uniformly scaled version of the vector video frame in FIG. 7a. The width of the scaled vector video frame is 240 and the height of the scaled vector video frame is 320. Scaled ball1 has a width value equal to 110.159 and a height value equal to 145.139. Scaled ball2 has a width value equal to 68.952 and a height value equal to 62.902. An example SVG description of the vector frame in FIG. 7b is as follows;

```
<?xml version=″1.0″ encoding=″UTF-8″ standalone=″no″?>
<svg
    xmlns:svg=″http://www.w3.org/2000/svg″
    xmlns=″http://www.w3.org/2000/svg″
    version=″1.0″
    width=″240″
    height=″320″
    id=″svg2″>
  <defs
        id=″defs4″ />
  <g
        id=″layer1″>
      <path id=”ball1” importance=”0.3” width=”110.159”
          height=”145.139” d=″M 340,303.79074 A
135.71428,148.57143 0 1 1 68.571442,303.79074 A
135.71428,148.57143 0 1 1 340,303.79074 z″
          style=″fill:#0000ff″ />
      <path id=”ball2” importance=”0.7” width=”68.952”
          height=”62.902” d=″M 634.28571,572.36218 A
94.285713,102.85714 0 1 1 445.71429,572.36218 A
          94.285713,102.85714 0 1 1 634.28571,572.36218 z″ style=
          ″fill:#008000″ />
  </g>
</svg>
```

FIG. 7c shows an example of a non-uniformly retargeted version of the vector video frame in FIG. 7a. The width and height of the retargeted vector video frame are similar to those of the scaled vector video frame in FIG. 7b. However, due to the difference in importance values of ball1 and ball2, ball2 is larger than ball1 in the retargeted vector video frame. The width and height of ball1 are, respectively, 77.1113 and 101.5973, whereas the width and height of ball2 are, respectively, 117.218 and 106.9334 after non-uniform retargeting. An example SVG description of the retargeted vector video frame in FIG. 7c is as follows;

```
<?xml version=″1.0″ encoding=″UTF-8″ standalone=″no″?>
<svg
    xmlns:svg=″http://www.w3.org/2000/svg″
    xmlns=″http://www.w3.org/2000/svg″
    version=″1.0″
    width=″240″
    height=″320″
    id=″svg2″>
  <defs
        id=″defs4″ />
  <g
        id=″layer1″>
      <path id=”ball1” importance=”0.3” width=”77.1113”
          height=”101.5973” d=″M 340,303.79074 A
135.71428,148.57143 0 1 1 68.571442,303.79074 A
135.71428,148.57143 0 1 1 340,303.79074 z″
          style=″fill:#0000ff″ />
      <path id=”ball2” importance=”0.7” width=”117.218”
          height=”106.9334” d=″M 634.28571,572.36218 A
94.285713,102.85714 0 1 1 445.71429,572.36218 A 94.285713,102.85714
          0 1 1 634.28571,572.36218 z″ style=″fill:#008000″ />
  </g>
</svg>
```

According to one example embodiment of the present invention, the operations described with respect to FIG. 1 are implemented in a user equipment. In this regard, a user equipment may convert a video frame to a vector format, perform uniform scaling, and perform non-uniform retargeting. In another example embodiment, the operations described with respect to FIG. 1 are implemented in server platform. The server, for example, receives a request, from a user equipment, for video data. The server identifies the display size of the user equipment based, for example, on information in the received request. The network server performs conversion of video frames to vector format, uniform scaling, and non-uniform retargeting of vector video frames. The user equipment may further send importance values associated with objects in the video frames to the server. The server then uses the received importance values in the retargeting process. In yet another embodiment, some operations of FIG. 1 may be performed by a user platform, while other are performed by a server platform. In this regard, for example, the server for example performs conversion of video frames to vector format, uniform scaling and/or determining of importance values. The user equipment may perform non-uniform retargeting. The server may further provide information regarding spatial detail levels and spatial detail constraints for different objects. The user equipment may use the spatial detail levels and spatial detail constraints in the retargeting process. For example, the server provides at least one data structure, e.g., a tree, a table and/or the like. For an object, the data structure provides one or more spatial detail levels associated, for example, with the same object at different sizes, and/or different states of detail. In the retargeting process, the user equipment for example searches the data structure to determine the appropriate state and/or size of the object based at least in part on the display size and/or importance value of the object.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
identifying one or more objects within a vector video frame;
determining one or more importance values for the one or more identified objects; and
retargeting the video frame based at least in part on at least one of the one or more importance values corresponding to at least one identified object.

2. The method of claim 1 wherein retargeting the video frame based on the at least one of the one or more importance values comprises:
determining at least one spatial detail constraint value for the at least one object; and
modifying at least one spatial detail level of the at least one object in response to a result of a comparison between the at least one spatial detail constraint and at least one current spatial detail level for the at least one object, wherein modifying said at least one spatial detail level of said at least one object comprises at least one of enhancing an generalizing said at least one object.

3. The method of claim 1, further comprising:
determining a desired display size; and
converting a raster video frame into the vector video frame; and
scaling the vector video frame, uniformly, to the desired display size.

4. The method of claim 3, further comprises:
segmenting the raster video frame based at least in part on color edges; and
subtracting a background region of the video frame.

5. The method of claim 1, wherein retargeting the video frame comprises retargeting the video frame with at least one of spatial coherence and temporal coherence, wherein retargeting with temporal coherence comprises maintaining at least one spatial detail level of at least one object throughout a series of video frames, and wherein retargeting with spatial coherence comprises maintaining a constant spatial detail level ratio between an object and at least another object in a video frame.

6. The method of claim 1, wherein identifying one or more objects comprises identifying facial features using at least one histogram associated with at least one facial feature.

7. An apparatus comprising:
a memory for storing a vector video frame; and
a processor configured to:
identify one or more objects within the vector video frame;
determine one or more importance values for the one or more identified objects; and
retarget the video frame based at least in part on at least one of the one or more importance values corresponding to at least one identified object.

8. The apparatus of claim 7 wherein the processor is further configured to:
determine at least one spatial detail constraint value for said at least one object; and
modify at least one spatial detail level of said at least one object in response to a result of a comparison between said at least one spatial detail constraint and said at least one spatial detail level for said at least one object, wherein modifying said at least one spatial detail level of said at least one object comprises at least one of enhancing and generalizing said at least one object.

9. The apparatus of claim 7, wherein the processor is further configured to:
determine a desired display size;
convert a raster video frame into the vector video frame; and
scale the vector video frame, uniformly, to the desired display size.

10. The apparatus of claim 9, wherein the processor is further configured to:
segment the raster video frame based at least in part on color edges; and
subtract a background region of the vector video frame.

11. The apparatus of claim 7, wherein the processor is further configured to retarget the video frame with spatial coherence or temporal coherence, wherein retargeting with temporal coherence comprises maintaining at least one spatial detail level of at least one object throughout a series of video frames, and wherein retargeting with spatial coherence comprises maintaining a constant spatial detail level ratio between an object and at least another object in a video frame.

12. The apparatus of claim 7, wherein the processor is further configured to identify facial features using at least one histogram associated with at least one facial feature.

13. A computer program product comprising at least one computer-readable storage medium having executable computer-readable program code instructions stored therein, the computer-readable program code instructions being configured to:
identify one or more objects within the vector video frame;
determine one or more importance values for the one or more identified object; and
retarget the video frame based at least in part on at least one of the one or more importance values corresponding to at least one identified object.

14. The computer program product of claim 13 wherein the computer-readable program code instructions being further configured to:
determine at least one spatial detail constraint value for said at least one object; and
modify at least one spatial detail level of said at least one object in response to a result of a comparison between said at least one spatial detail constraint and said at least one spatial detail level for said at least one object, wherein modifying said at least one spatial detail level of said at least one object comprises at least one of enhancing and generalizing said at least one object.

15. The computer program product of claim 13, wherein the computer-readable program code instructions being further configured to:
determine a desired display size;
convert a raster video frame into the vector video frame; and
scale the vector video frame, uniformly, to the desired display size.

16. The computer program product of claim 15, wherein the computer-readable program code instructions being configured, in identifying the one or more objects, to:
segment the raster video frame based at least in part on color edges; and
subtract a background region of the video frame.

17. The computer program product of claim 13, wherein the computer-readable program code instructions being configured to retarget the vector video frame with spatial coherence or temporal coherence, wherein retargeting with temporal coherence comprises maintaining at least one spatial detail level of at least one object throughout a series of video frames, and wherein retargeting with spatial coherence comprises maintaining a constant spatial detail level ratio between an object and at least another object in a video frame.

18. The computer program product of claim 13, wherein the computer-readable program code instructions being configured to identify facial features using at least one histogram associated with at least one facial feature.

19. An apparatus comprising:
means for identifying one or more objects within a vector video frame;
means for determining one or more importance values for the one or more objects; and
means for retargeting the vector video frame based at least in part on at least one of the one or more importance values corresponding to at least one object.

20. The apparatus of claim 19, wherein means for retargeting the video frame based at least in part on said at least one importance value comprises:
means for determining at least one spatial detail constraint value for said at least one object; and
means for modifying at least one spatial detail level of said at least one object in response to a result of a comparison between said at least one spatial detail constraint and said at least one spatial detail level for said at least one object, wherein modifying said at least one spatial detail level of said at least one object comprises at least one of enhancing and generalizing said at least one object.
